(19) United States
(12) Patent Application Publication
(10) Pub. No.: US 2021/0042673 A1
(43) Pub. Date: Feb. 11, 2021

(54) SYSTEM AND METHOD FOR AUTHENTICATION AND AUTOMATIC QUEUING

(71) Applicant: JPMorgan Chase Bank, N.A., New York, NY (US)

(72) Inventors: Alex LIEBERMAN, Marlboro, NJ (US); Nicholas M. LORE, Pearl River, NY (US)

(21) Appl. No.: 15/148,387

(22) Filed: May 6, 2016

(51) Int. Cl. G06Q 10/06; G06Q 10/10; G06K 9/00

(52) U.S. Cl. CPC G06Q 10/0633; G06K 9/00288; G06Q 10/10

(57) ABSTRACT

The invention relates to an authentication interface located at a branch location comprising: a recognition unit, positioned in a direction towards an entrance of the branch location, that identifies a visitor based on a physical biometric, the recognition unit comprising at least one camera that receives image data associated with the visitor and performs a facial recognition based on the image data; a processing unit, coupled to the recognition unit, that identifies the visitor as a customer based on the facial recognition, the customer having a customer identifier associated with a customer profile; the processing unit generates a customer interaction event based on the customer profile and places the customer in a queue for servicing; and an interactive display, coupled to the queuing unit and processing unit, that displays a customized message to address the customer interaction event.

### FIELD OF THE INVENTION

The invention relates generally to a system and method for authentication and automatic queuing, and more particularly to a system and method that authenticates customers, automatically places them in a queue and connects customers with an appropriate servicing entity.

### BACKGROUND OF THE INVENTION

When customers enter a branch or other location, they enter a general line and wait their turn for a teller. The customer may have simple transaction or more complex needs that require personalized attention. However, given the nature of the current branch location and limited about of information about the customer, it is difficult to provide a customized interaction.

These and other drawbacks currently exist.

### SUMMARY OF THE INVENTION

According to one embodiment, the invention relates to an authentication interface located at a branch location comprising: a recognition unit, positioned in a direction towards an entrance of the branch location, that identifies a visitor based on a physical biometric, the recognition unit comprising at least one camera that receives image data associated with the visitor and performs a facial recognition based on the image data; a processing unit, coupled to the recognition unit, that identifies the visitor as a customer based on the facial recognition, the customer having a customer identifier associated with a customer profile; the processing unit generates a customer interaction event based on the customer profile and places the customer in a queue for servicing; and an interactive display, coupled to the queuing unit and processing unit, that displays a customized message to address the customer interaction event.

The method may be conducted on a specially programmed computer system comprising one or more computer processors, mobile devices, electronic storage devices, and networks.

The invention also relates to method for implementing an authentication interface, the method comprising the steps of: identifying, via a processing unit coupled to a recognition unit, a visitor as a customer based on a facial recognition, the customer having a customer identifier associated with a customer profile; the processing unit generates a customer interaction event based on the customer profile and places the customer in a queue for servicing; the recognition unit being positioned in a direction towards an entrance of the branch location and comprising at least one camera that receives image data associated with the visitor and performs the facial recognition based on the image data, and displaying, via an interactive display, coupled to the queuing unit and processing unit, a customized message to address the customer interaction event.

The computer implemented system, method and medium described herein provide the advantages of authentication and automatic queuing, according to various embodiments of the invention. The innovative system and method provide customized and prompt service for visitors whether a customer or potential customer as they enter a branch location of a financial institution. The system identifies the visitor and for existing customers, the system retrieves profile data to provide customized attention and service. Customers can also pre-stage transactions, e.g., one or more ATM transactions, prior to entering the branch location thereby providing convenience and time efficiencies. Other advantages that can be provided are customer loyalty and retention due to the increased satisfaction of the account holder. The system provides convenience and security for customers as they transact with various financial devices with a branch location. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for implementing authentication and automatic queuing, according to an exemplary embodiment of the invention.

FIG. 2 is an exemplary diagram of an Authentication Interface, according to an embodiment of the present invention.

FIG. 3 is an exemplary flowchart of a method for authentication and queuing, according to an embodiment of the present invention.

FIG. 4 is an exemplary flowchart of a method for authentication and queuing, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to an authentication system that identifies a visitor as they enter a physical branch or other location associated with a provider, e.g., financial institution. As the visitor enters the branch, he or she may be identified as a customer or potential customer. For an existing customer, the system may identify the customer by name, identifier, nickname, icon, image, etc. and access the customer's profile for a customized experience. The profile may include data concerning the customer's account, prior interactions (e.g., past branch visits, etc.), potential concerns and/or reason for the branch visit. The system may also authenticate the customer, which may be through a mobile device identification, password, identifier, PIN, biometric, etc. Upon identification and authentication, the system may generate a customer interaction event and place the customer in an appropriate queue for service where the customer is prioritized accordingly.

For potential customers, an embodiment of the present invention may initiate generation of a profile and engage the potential customer to open an account or otherwise start a relationship with the provider. Based on the visitor's input, an appropriate service representative may be assigned to the potential customer. Also, the representative may provide general information about available service and products to the customer based on the initial input.

An embodiment of the present invention may maintain and manage a metric of visitors and their purpose to further enhance services and knowledge base of staff based on the metrics. For example, at any given time, the system of an embodiment of the present invention may identify visitors currently at a branch location. Based on the needs and/or preferences of the current visitors, the system may organize the visitors into queues for expeditious and tailored services. For example, a branch may have a high number of customers who want to make ATM transactions. If all the machines are occupied, a customer may be directed to a teller who can provide a withdrawal of funds. If the system recognizes that the customer always withdraws $100 with each visit, the teller may greet the customer by name and have the funds ready when the customer approaches. Further, the system may recognize that this particular customer enjoys a personalized experience and would prefer to interact with a teller as opposed to an automatic ATM withdrawal. During the interaction, the teller may also provide information about a new credit card that provides hotel and travel perks. Because the system recognizes that this customer frequently travels, this credit card may be of particular interest.

An embodiment of the present invention may provide various functions including appointment check-in, dynamic marketing, queue management and traffic assignment.

For an appointment check-in, a customer may receive a notification on their device that they are checked-in. An appropriate service representative, e.g., banker or teller, may then be notified of the customer's arrival and may be able to “claim them.” The customer's profile may be pre-populated with appropriate data, along with data relating to a pre-staged transaction, if applicable.

A branch location may include various displays, devices and/or interactive interfaces that provide real-time data regarding advertising, instructions, opportunities, information, etc. For dynamic marketing, the various displays may alter content based upon the profile of known customers at the branch location. For example, the branch location may include various displays placed strategically around a customer service area. Some displays may be prominently displayed so that anyone in the branch may view them. Other displays may be strategically placed with limited view for those individuals within a specific viewing angle or location. An embodiment of the present invention may detect where the customer is located within the branch location, based on location technology including Global Positioning System (GPS), Bluetooth Low Energy (BLE), near field communication (NFC), beacon technology, etc. For example, the strategically placed displays may be coordinated when a particular customer is within viewing proximity. While a particular customer is engaging a bank teller, the specific display next to the bank teller may be customized to display marketing information about a product or service of interest to the customer based on the customer's profile and/or other data. Moreover, as the customer moves around the branch, an embodiment of the present invention may detect the customer's current location and signal displays within viewing proximity to display relevant information specific to the customer.

According to another example, an embodiment of the present invention may retrieve past interactions including website visits, past searches within the website (e.g., search for a particular product or service), inquiries (e.g., CSR interactions), visits to product or service information pages, etc. Upon entering the branch location and identification, an embodiment of the present invention may provide additional information about a product or service the customer appears to be interested in. In addition, because the system recognizes a likelihood of customer interest, the system may offer a customized incentive (e.g., discount, additional service, upgrade, etc.). For example, a customer may contact a financial institution about a certain credit card or visit an online website looking for a specific type of card. The same customer may then visit a branch location the following day. An embodiment of the present invention may recognize the customer and associate past inquiries about the specific card with the customer and then prompt relevant marketing material about the card to be displayed as the customer enters and walks around the branch location.

For queue management, if the customer did not have an appointment, the customer may be placed into a queue automatically. The customer may then be prompted to indicate a reason for visiting on their mobile device. Other information may be collected as well. If the customer has an appointment, the customer may be placed in an appropriate queue for a customized experience. Also, if the customer is visiting for a simple and/or automated transaction, such as an ATM interaction, the customer may be directed to an available and appropriate device. If applicable, the device may be prepared and/or pre-staged for a personal interaction with the customer. Also, the queue may be modified based on events, factors and/or other considerations. For example, a visitor may be initially placed in a general queue for service. Upon additional information (e.g., the visitor needs to speak to a financial advisor about a car loan), the visitor may be moved to a different queue or instructed to meet with financial advisor John, who will greet him shortly. According to another example, a particular service provider may have specialized knowledge about a specific product that a customer is interested in. When that service provider is available, the customer of interest may be moved up the queue for immediate attention and service by this particular service provider.

For traffic assignment, if the customer has indicated a reason for visiting or the customer has a pre-staged transaction, the customer may be directed to an appropriate location within the branch (e.g., through a push notification to their mobile device, or through a screen in the branch.). For example, an embodiment of the present invention may recognize that a certain customer only enters a branch location to make express ATM withdrawals of $50 on Mondays and $80 on Fridays. When this customer enters a branch location, the system may identify the customer and welcome him by name and direct him to the next available ATM. This ATM may then display, as an initial page, an option to withdraw $50 if the current day is a Monday or an option to withdraw $100 if the current day is a Friday. The customer may then simply select “confirm” to withdraw the funds. Also, the customer may hold up a mobile device (or other device) for authentication and confirmation to initiate an automated transaction.

While the exemplary illustrations are directed to a branch location of a financial institution, the various embodiments of the present invention may be applied to various service-based industries, including furniture shopping, car purchases, venue rental, wedding-related services, etc.

The following descriptions provide different configurations and features according to exemplary embodiments. These configurations and features may relate to providing financial services through financial services machines. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

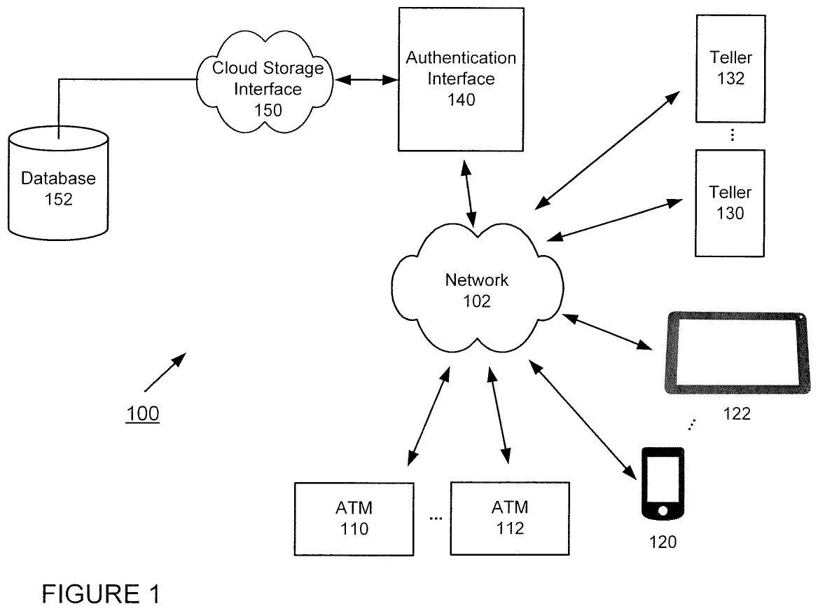

FIG. 1 illustrates a schematic diagram of a system 100 is shown, according to an exemplary embodiment. As illustrated, network 102 may be communicatively coupled with one or more data devices including, for example, financial transaction machine 110, 112, tablet computing device 120, 122 and teller interfaces 130, 132. Financial transaction machines 110, 112 may be fully automated devices, also represented as Automated Teller Machines (ATMs). Devices 120, 122 may represent mobile devices, including mobile phones, smart devices, pads that may be stand-alone devices or carried by a customer service representative or other representative. Network 102 may communicate with an Authentication Interface 140 that identifies and/or authenticates customers as well as potential customers as they visit a location. The Authentication Interface 140 may include camera, microphones, and various inputs. Authentication Interface 140 may be coupled to a cloud storage interface 150 that stores data in a remote location, as illustrated by database 152. The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The network 102 may be a wireless network, a wired network or any combination of wireless network and wired network. For example, the network 102 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, the network 102 may support an Internet network, a wireless communication network, a cellular network, Bluetooth, or the like, or any combination thereof. The network 102 may further include one, or any number of the exemplary types of networks mentioned above operating as a stand-alone network or in cooperation with each other. The network 102 may utilize one or more protocols of one or more network elements to which it is communicatively coupled. The network 102 may translate to or from other protocols to one or more protocols of network devices. Although the network 102 is depicted as one network for simplicity, it should be appreciated that according to one or more embodiments, the network 102 may comprise a plurality of interconnected networks, such as, for example, a service provider network, the Internet, a cellular network, corporate networks, or even home networks, or any of the types of networks mentioned above.

Data may be transmitted and received via network 102 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 illustrates individual devices or components, it should be appreciated that there may be several of such devices to carry out the various exemplary embodiments. For example, the financial transaction device 110, 112 may represent several EBKs, any one of which may be used to practice the various exemplary embodiments. Again, the use of EBKs is meant to be non-limiting and, may include, but are not limited to, automated teller machines (“ATMs”), personal teller machines (“PTMs”), financial self-service devices, financial services kiosks, financial transaction devices, portable electronic devices, money machines, cash machines, bank machines, and bancomats, for example. The financial transaction device 110, 112 may be associated with and/or operated by a financial institution. The financial transaction machine may be connected directly with the financial institution, or indirectly using a payment network, processor, or gateway.

The financial transaction machine 110, 112 may comprise, for example, a display, which may be touch-sensitive or otherwise; an alpha-numeric and/or QWERTY keyboard, either physical or virtual, for receiving input; a pointing device, such as a trackball, track wheel, or mouse, for example; a scanning camera to scan items displayed or presented by customers or potential customers; a cash dispenser; a check and/or cash receiver; a printer, such as for printing receipts, for example; a biometric scanner, such as a fingerprint or retinal scanner; and communication chipsets for communicating with other devices, such as ATMs 110, 112, devices, 120, 122, interfaces 130, 132, 140 as well as others, for example.

The financial transaction machine 110, 112 may also include a reader (e.g., NFC, BLE, WiFi, LTE, etc.) to establish wireless communication with mobile devices. Other forms of wireless, contactless and radio communications may be supported.

Devices 120, 122 may include any mobile or computing device, such as a laptop computer, a personal digital assistant, a smartphone, a smartwatch, smart glasses, other wearables or other computing devices capable of sending or receiving network signals. Devices 120, 122 may have an application installed that is associated with the financial institution.

Authentication Interface 140 may perform operations associated with processing information and data associated with customer identification, authentication and automatic queuing. Authentication Interface 140 may comprise one or more servers and/or computers, each having one or more computer processors associated therewith. In various exemplary embodiments, the Authentication Interface 140 may be a specific computing device to support exemplary embodiments as described herein.

Authentication Interface 140 may be communicatively coupled to Cloud Storage Interface 150 and Database 152. Database 152 may contain data and information used by the system 100. For example, Database 152 may store account data for customers as well as customer profile data. Database 152 may also contain additional information related to the operation and administration of the system 100. Database 152 may include any suitable data structure to maintain the information and allow access and retrieval of the information. For example, Database 152 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Database 152 may be any suitable storage device or devices. The storage may be local, remote, or a combination thereof with respect to Database 152. Database 152 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Database 152 may have back-up capability built-in. Communications with Database 152 may be over a network, such as network 102, or communications may involve a direct connection between Database 152 and Authentication Interface 140, as depicted in FIG. 1.

Having described an example of the hardware, software, and data that can be used to run the system, an example of the method and customer experience will now be described. The method will be described primarily as an example in which a customer downloads a software application (sometimes referred to as an “app”) and uses it to perform banking transactions and/or other functionality, including making purchases. However, those skilled in the art will appreciate that the principles of the invention can be applied to related circumstances, such as where the entity providing the app is a business other than a merchant, or where the merchant app functionality is provided through a browser on the customer's mobile device rather than through a software application (app) downloaded to the customer's mobile device, and with purchases from various providers.

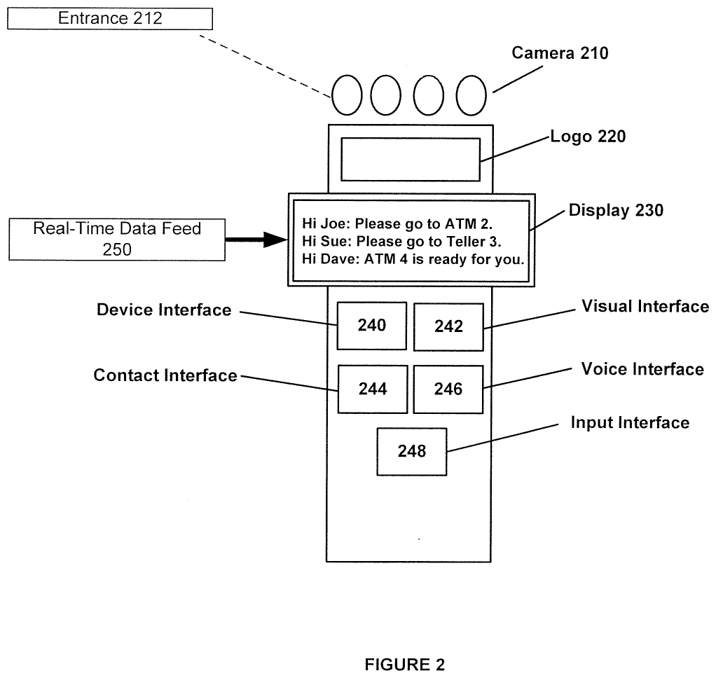

FIG. 2 is an exemplary diagram of an Authentication Interface, according to an embodiment of the present invention. FIG. 2 illustrates an exemplary embodiment of an Authentication Interface 200. An embodiment of the present invention is directed to a mobile-based reservation system, as well as a presence-based reservation system. An Authentication Interface of an embodiment of the present invention may include a voice to text terminal, voice recognition unit, a camera for facial recognition as well as an interface for mobile device based recognition.

As shown in FIG. 2, Authentication Interface 200 may comprise a camera or camera array, shown as 210. Camera 210 may include a single camera as well as multiple cameras pointed in different angles. For example, each camera may be pointed towards an entrance of the branch, shown by Entrance 212. Also, the camera(s) may be motion sensing. The camera(s) may also move and/or zoom in and out as well as up or down to get a better view of an individual (e.g., based on height, obstructed view, etc.). While camera 210 is illustrated on top of the interface, the cameras may be integrated in other positions in and/or around Authentication Interface 200. For example, additional cameras may be positioned above and/or around the branch. Images, videos and data may be captured by the cameras and then conveyed to a processing unit. The processing unit may be within Authentication Interface 200 as well as remote from. Interface 200 may also include a Logo Section 220, this Section may be interactive and dynamic. Logo Section 220 may also include customized marketing data. Additional marketing interfaces may be displayed at the Authentication Interface and at other areas within the branch location.

Authentication Interface 200 may include Display 230. Display 230 may communicate welcome messages to visitors as they enter the branch location. The welcome messages may include a name, identifier, nickname, image, logo, image, animation, video, hologram, 3D graphic, etc. A visitor may interact with Authentication Interface 200 in various ways. For example, interfaces may include Device Interface 240, Visual Interface 242, Contact Interface 244, Voice Interface 246 and Input Interface 248. Display 230 may provide instructions on where the customer can be serviced (e.g., ATM 2, Teller 3, ATM 4, etc.). Also, current wait times and other notifications may be provided to the customer via the Display as well as through the customer's mobile device.

For example, Device Interface 240 may include beacon technology and other proximity sensing technology. The interface may also provide contactless authentication. For example, a mobile device may be used to provide authentication through a single, token, identifier, etc. For example, the customer may place (or motion) the mobile device near or in front of Interface 240 for authentication, identification, etc.

Visual Interface 242 may include a facial recognition feature. Visual Interface may be connected or communicative coupled to one or more cameras, represented by 210. Visual Interface 242 may perform facial recognition as visitors approach Authentication Interface 200. Visual interface 242 may also perform identification through a gesture, facial expression, eye scan and/or other visual biometric.

Contact Interface 244 may receive biometric and/or other personal data, including fingerprint data, swipe pattern, gesture, and other identifying contact. According to another example, a customer may insert a card, RFID, token and/or other interaction to identify the customer or visitor.

Voice Interface 246 may include a voice recognition feature, voice command feature, voice to text feature and other voice related functionality. For example, Voice Interface 244 may receive a customer's unique voice pattern for customer identification. For example, Voice Interface 244 may request a visitor to speak (e.g., say a greeting, repeat a phrase, say a name, etc.) or answer a question to provide a voice sample or voice pattern. Input Interface 246 may be configured to receive other forms of input, either active, passive or through mobile device.

Other forms of customer input may be received by Input Interface 248. For example, a new visitor (e.g., first time visitor, someone who has not interacted with the company before, etc.) may input an identifier. The new visitor may also share contact information with the Authentication Interface via a mobile phone, using near field or similar technology. Input Interface 248 may also include a touchpad, keyboard and/or other input mechanism.

Display 230 may receive and/or process data from various sources. Data may include profile data, transaction data, past contact data, merchant data, social media data, etc. Profile data may have various sources, including from a phone conversation, IVR, text message, SMS, email, a website (e.g., social media website, bank website, private message, etc.), in person, bank teller, merchant, service representative and/or other mechanism. Authentication Interface may also receive real-time data, as shown by 250. Real-time data may include current servicing times, available tellers and representatives, an indication that a high volume of customers with reservations are approaching the branch location, check-ins, social media updates, etc. An embodiment may process customer data to generate a personalized customer service experiencing in the branch location. For example, based on the customer interactions, the system may recognize that the customer recently had a bad experience with a customer service representative and because this customer is a high wealth customer, the system may generate a highly tailored interaction. Further, this customer may be moved up the queue for immediate and prompt attention.

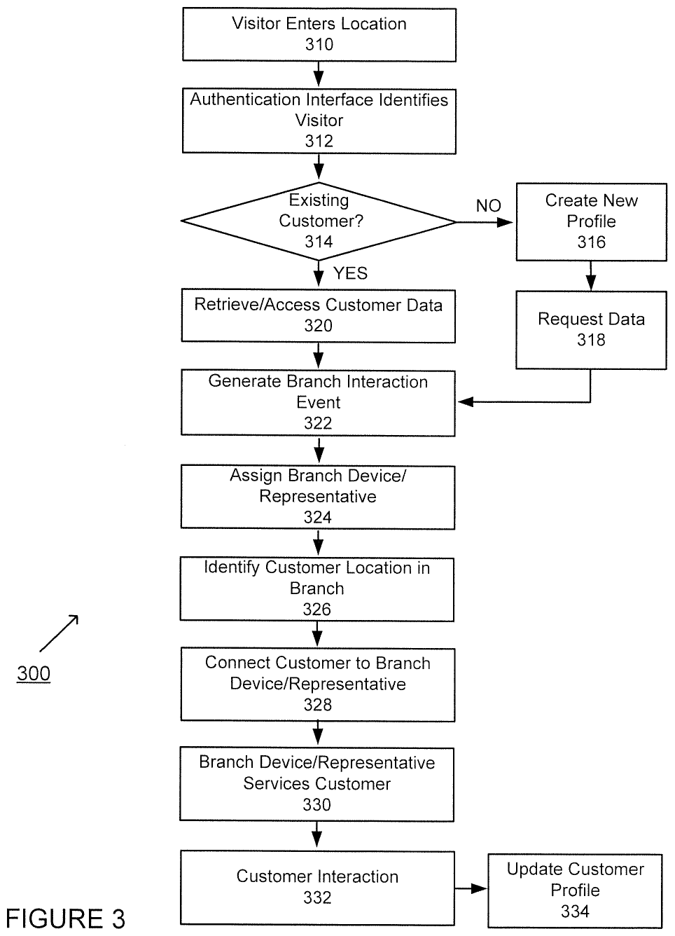

FIG. 3 is an exemplary flowchart of a method for authentication and queuing, according to an embodiment of the present invention. At step 310, a visitor may enter a location. At step 312, an authentication interface identifies the visitor. At step 314, the interface may determine whether the visitor is an existing customer or potential customer. For a potential customer, the system may create a potential or new customer profile, at step 316. At step 318, the interface may request data from the potential customer. If the visitor is an existing customer, the interface may access customer data, from a profile, for example, at step 320. At step 322, the interface may generate a branch interaction event. At step 324, the interface may assign a branch device or representative to the customer for the branch interaction event. At step 326, the system may identify the customer's location in the branch. At step 328, the interface may direct the customer to an assigned branch device or representative. At step 330, the branch device or representative may service the customer for the branch interaction event. At step 332, the system may interact with the customer. At step 334, the interface may update the customer profile with data about the branch event. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 310, a visitor may enter a location. The location may be a branch location of a financial institution. The location may include ATM devices, tellers, financial advisors and/or other devices and service providers. The location may also include other service-based providers.

At step 312, an authentication interface identifies the visitor. At or near the entrance, an authentication interface may identify the visitor and display an appropriate greeting. Upon identification, the authentication interface may engage and interact with the visitor. Also, the authentication interface may request further authentication information. The authentication interface may also access authentication information from a mobile device associated with the visitor. This may be done with or without the customer's active participation. Also, if a particular customer poses a high fraud potential based on the initial identification, additional credentials (e.g., biometric, security code, etc.) may be requested.

At step 314, the interface may determine whether the visitor is an existing customer or a potential customer. If the visitor's identity does not match profiles in a database, the system may determine that the visitor is not a current customer. If the visitor is a potential customer, a potential or new customer profile may be created, at step 316. At step 318, the interface may request data from the potential customer, such as the reason for the potential customer's visit. If no reason is provided, the potential customer may be placed in a general queue for service. Also, the system may assign a representative to the potential customer to gain further insight and information about the customer's needs and preferences.

If the visitor is an existing customer, the interface may access customer data, from a customer profile, for example, at step 320. The customer profile may be stored in one or more databases or other memory components. The customer profile may include various forms of customer information, such as customer identification data (e.g., biometrics, demographic, etc.), customer preference data, prior history data (e.g., prior history data at this specific location, prior history for entire company, etc.); existing products/services; account data; transaction data (e.g., merchant data, etc.); web interaction data (e.g., search, web pages visited, etc.); app interaction data; phone interaction data (e.g., IVR, CSR, phone complaint, etc.); type of customer (e.g., premium, high wealth, etc.); past fraud data (e.g., customer's account was compromised last month; customer has been a victim of identity theft, etc.) and/or other relevant data. For example, if a fraud potential is high, the system may request additional credentials for authentication. Customer profile may also provide insight as to how the customer may react, e.g., this customer is patient; this customer made X many complaints in the last 3 months; company promised to provide better service; loyal customer; new customer; this customer was referred to us by a high wealth customer, etc.

At step 322, the interface may generate a branch interaction event. Based on customer identification and profile data, the system may identify a customized experience for the customer. An embodiment of the present invention may incorporate machine learning (e.g., artificial intelligence, etc.) to learn the customer's behavior and preferences. This data may be used to determine an optimal manner to service the customer at branch locations and other avenues of contact.

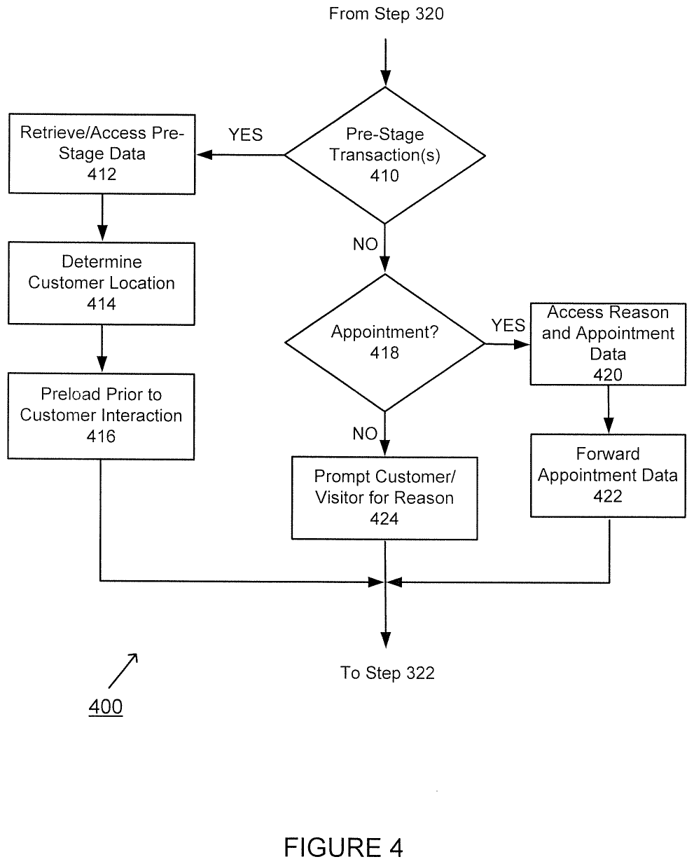

As illustrated in FIG. 4, the authentication interface may also access any pre-stage data and reservation data. For example, pre-stage data may involve a pre-staging one or more transactions prior to entering the location or prior to be serviced. In this example, a customer may pre-stage a series of simple and complicated deposits for a small business and ATM withdrawals from multiple accounts. The interface of an embodiment of the present invention may initiate preparation of the deposits as well as have the funds available for withdrawal from the multiple accounts so that when the customer enters the location and is properly identified (and authenticated), the customer will be directed to a teller or device that will be ready to service the customer with the pre-staged transactions. Also, a customer may request a reservation at a branch location for a specific reason, e.g., discuss refinancing options, open a new account, etc. This data may be received by the system to place the customer in an appropriate queue for expeditious service and a customized experience.

At step 324, the interface may assign a branch device or entity to the customer for the branch event. An embodiment of the present invention automatically places a customer in a queue based on customer identification, customer profile and/or other data. Also, a branch location may offer multiple types of services, where each type of service or service representative/device may have a separate queue based on the customer's needs. The queue may be updated and/or modified. For example, a queue may be modified based on an urgent request, a timeout, closing time is approaching, an agent with specialized knowledge is now ready to service a customer with a specific question, etc.

At step 326, the system may identify the customer's location in the branch. The system may use location technology to identify the customer's location and proximity to a service device and/or service representative. The customer's location may also indicate when a likely or expected transaction can be set-up. For example, if the customer is 2 minutes away from being serviced, the device or representative may initiate preparation for one or more (likely or expected) transactions. Also, the customer's location may be used to provide prompt personal attention from a nearby representative. For example, each representative may have a mobile device that provides customer location and communicates prompts with personalized information (e.g., this customer is interested in a new credit card, etc.)

At step 328, the interface may direct the customer to an assigned branch device. For example, the authentication interface and/or other interface located in the branch location may display a message to the customer. Also, the customer may receive a message on the customer's mobile device via push notification or other messaging technology.

At step 330, the branch device or representative may service the customer for the branch interaction event. For example, the customer may be directed to an ATM that is ready to service the customer. Also, the ATM may be preloaded with a pre-staged transactions. The ATM may display options based on the customer's prior interactions. Also, the customer may be directed to a representative who has information ready for the customer. For example, the customer may be exploring loan options for a small business. The system may notify a financial advisory that a customer seeking loan information is here. The financial advisory may then meet with the customer and provide specific loan options tailored to the customer's small business.

At step 332, the system may interact with the customer. During or at the end of an interaction, the system may provide customized information and offers to the customer. For example, as the ATM transaction is coming to an end, the system may recognize that the customer has multiple credit cards and is incurring monthly fees on some. The system may offer an consolidated card that provides benefits that are appealing to the customer. Also, the system may partner with various other merchants, service providers and/or other providers to generate and provide customized offers.

At step 334, the interface may update the customer profile with data about the branch interaction event. The system of an embodiment of the present invention may capture customer data and update the customer profile. For example, if the customer responds positively to a customized offer, the customer profile may be updated accordingly and similar customized offers may be provided to the customer during the next interaction. Negative customer reaction may also be stored to better respond to the customer during the next interaction (e.g., the customer may request no future offers from a particular merchant, etc.).

FIG. 4 is an exemplary flowchart of a method for authentication and queuing, according to an embodiment of the present invention. At step 410, an authentication interface may determine whether a customer has pre-staged one or more transactions. If yes, the interface may retrieve or access the pre-stage transaction data, at step 412. At step 414, the system may identify the customer's location in the branch location. At step 416, the pre-staged transaction data may be forward to servicing device or representative. If no, the authentication interface may determine whether the customer scheduled an appointment, at step 418. If yes, the interface may retrieve or access the appointment including a reason for the visit, at step 420. The appointment data may be forwarded, at step 422. If no, the interface may prompt the customer for a reason, at step 424. The order illustrated in FIG. 4 is merely exemplary. While the process of FIG. 4 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

According to an exemplary illustration, step 410 may be subsequent to step 320 in FIG. 3. At step 410, an authentication interface may determine whether a customer pre-staged one or more transactions. If yes, the interface may retrieve the pre-stage transaction data, at step 412. For example, customers may use a mobile app on a mobile device to initiate a desired ATM transaction before the customer arrives at the ATM. Transactions may include banking requests, such as withdrawals, deposits, cashier's checks, reprinting of a debit card, etc. The pre-stage transactions may include multiple simple transactions as well as complex transactions.

According to another example, a customer may speak a series of transactions into a mobile device, the mobile device may then convert the voice commands into a series of steps that may then be communicated to a terminal device upon user initiation. Also, a customer may pre-stage a withdrawal of $120 from a checking account in a particular denomination (e.g., 24 five dollar bills).

An embodiment of the present invention may recognize that a customer withdraws $100 every Friday after work from a particular ATM. Accordingly, the customer's mobile device may pre-stage this transaction so that the customer can walk up to an ATM and simply confirm the withdrawal. Also, based on the customer's geographic location, the customer's mobile device may receive alerts, notifications, reminders, etc. The customer's geographic location may also be used to authenticate or confirm the customer is who they say they are. Customers may also pre-stage cash back transactions at merchants, retailers, hotels, movie theaters, service providers, etc.

At step 414, the system may identify the customer's location in the branch location. At step 416, the pre-staged transaction data may be forward to servicing device or representative. Based on the customer's location, the system may initiate preparation for the pre-staged transaction. For example, if the customer is within 60 seconds of being serviced, the transactions may be initiated.

If no, the authentication interface may determine whether the customer scheduled an appointment, at step 418. According to an exemplary embodiment, the appointment may be generated using machine learning or other automated processing based on the customer's inputs, responses and/or other data. If yes, the interface may retrieve or access the appointment including a reason for the visit, at step 420. For example, this information may be received from an input in the customer's mobile device. The appointment data may be forwarded, at step 422. If no, the interface may prompt the customer for a reason, at step 424. For example, the customer may select from a plurality of options. This additional input may be then used to provide a customized experience. If applicable, the interface may also retrieve data from the customer's profile to determine a reason or a potential reason. According to an exemplary illustration, step 424 may prior to step 322 in FIG. 3.

Although the foregoing description has focused primarily on a financial institution assembling relevant data sets, processing the data, and sending the relevant data at appropriate times to its customer, the system may be operated and maintained by other types of commercial entities who may configure the system to provide similar advantages to their customers. In additional, while the foregoing description has focused primarily on the customer spend, the principles of the invention can be applied to other vendors and entities where the operating entity can assemble and provide relevant, timely information to enhance the customer's experience.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, FIG. 1 includes a number of servers and user communication devices 120, 122, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable faun such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices 120, 130 or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. An authentication interface terminal located at a branch location comprising:
a recognition unit, positioned in a direction towards an entrance of the branch location, that identifies a visitor based on a physical biometric, the recognition unit comprising at least one camera that receives image data associated with the visitor and performs a facial recognition based on the image data;
an authentication interface terminal configured to receive biometric contactless, and contact-based customer authentication inputs;
a processor, coupled to the recognition unit and the input interface, configured to:
determine if the visitor, based on the facial recognition, is an existing customer or a potential customer by cross-referencing a set of branch maintained customer profiles;
authenticating, upon determining the visitor is an existing customer, the visitor's identity based on one or more customer authentication inputs received from the visitor at the authentication terminal;
accessing, upon determining the visitor is an existing customer, the visitor's customer profile, the customer profile including customer account data, prior interaction history, and potential customer concerns, the prior interaction history including visits to the website of a financial entity for the branch location, searches for particular products or services on the website, and interactions with one or more customer service representatives for the financial entity;
access, upon determining the visitor is an existing customer, visitor created pre-stage data comprising one or more desired transactions;
generate, based on machine learning applied to the visitor's customer profile and the visitor created pre-stage data, a customer interaction event, the customer interaction event comprising one or more desired visitor transactions place the visitor in a queue for servicing based on the customer interaction event; and
an interactive display, coupled to the queue and the processor, that displays a customized message to address the customer interaction event and further direct the customer to a service in the branch location;
wherein the queue is associated with one of a plurality of different services supported at a plurality of different locations at the branch location; and
one or more interface displays coupled to the processor and positioned in the branch location, wherein the processor detects the customer's current location and displays one or more personalized messages comprising one or more of advertisements, opportunities, and instructions, on one or more of the interface displays in viewing proximity to the customer's current location.

2. The authentication interface of claim 1, wherein the recognition unit performs customer authentication using a mobile device associated with the customer.

3. The authentication interface of claim 1, comprising a near field communication (NFC) reader to communicate with a mobile device associated with the customer.

4. The authentication interface of claim 1, wherein the processor receives reservation data associated with the customer.

5. The authentication interface of claim 1, wherein the processor receives pre-staged data for one or more transactions.

6. (canceled)

7. (canceled)

8. The authentication interface of claim 1, wherein the customer profile comprises prior interaction history.

9. The authentication interface of claim 1, wherein the customer interaction event comprises a plurality of transactions to be performed at the branch location.

10. The authentication interface of claim 1, wherein data associated with the customer interaction event is used to update the customer profile.

11. A computer implemented method for implementing an authentication interface terminal located at a branch location comprising the steps of:
receiving, via an authentication interface terminal, one or more of a biometric, a contactless, and a contact-based customer authentication input;
identifying, via a processor coupled to a recognition unit and the input interface, a visitor as a customer based at least on a facial recognition;
determining, via the processor and based on the facial recognition, if the visitor is an existing customer or a potential customer by cross-referencing a set of branch maintained customer profiles;
authenticating, via the processor and upon determining the visitor is an existing customer, the visitor's identity based on one or more customer authentication inputs received from the visitor at the authentication terminal;
accessing, via the processor and upon determining the visitor is an existing customer, the visitor's customer profile, the customer profile including customer account data, prior interaction history, and potential customer concerns, the prior interaction history including visits to the website of a financial entity for the branch location, searches for particular products or services on the website, and interactions with one or more customer service representatives for the financial entity;
accessing, via the processor and upon determining the visitor is an existing customer, visitor created pre-stage data comprising one or more desired transactions;
generating, via the processor, based on machine learning applied to the visitor's customer profile and the visitor created pre-stage data, a customer interaction event, the customer interaction event comprising one or more desired visitor transactions placing the visitor in a queue for servicing based on the customer interaction event; the recognition unit being positioned in a direction towards an entrance of the branch location and comprising at least one camera that receives image data associated with the visitor and performs the facial recognition based on the image data, and
displaying, via an interactive display, coupled to the queue and the processor, a customized message to address the customer interaction event and further direct the customer to a service in the branch location;
wherein the queue is associated with one of a plurality of different services supported at a plurality of different locations at the branch location; and
displaying one or more personalized messages comprising one or more of advertisements, opportunities, and instructions on one or more branch location interface displays, coupled to the processor, and in viewing proximity to the customer's current location and coupled to the processor.

12. The method of claim 11, wherein the recognition unit performs customer authentication using a mobile device associated with the customer.

13. The method of claim 11, comprising a near field communication (NFC) reader to communicate with a mobile device associated with the customer.

14. The method of claim 11, wherein the processor receives reservation data associated with the customer.

15. The method of claim 11, wherein the processor receives pre-staged data for one or more transactions.

16. (canceled)

17. (canceled)

18. The method of claim 11, wherein the customer profile comprises prior interaction history.

19. The method of claim 11, wherein the customer interaction event comprises a plurality of transactions to be performed at the branch location.

20. The method of claim 11, wherein data associated with the customer interaction event is used to update the customer profile.
